(19) United States
(12) Patent Application Publication
(10) Pub. No.: US 2010/0088726 A1
(43) Pub. Date: Apr. 8, 2010

(54) AUTOMATIC ONE-CLICK BOOKMARKS AND BOOKMARK HEADINGS FOR USER-GENERATED VIDEOS

(75) Inventors: Scott Curtis, Durham, NC (US); Richard J. Walsh, Raleigh, NC (US); Ravi Reddy Katpelly, Durham, NC (US)

Correspondence Address: WITHROW & TERRANOVA CT, 100 REGENCY FOREST DRIVE , SUITE 160, CARY, NC, 27518, US

(73) Assignees: CONCERT TECHNOLOGY CORPORATION, Durham, NC (US); PORTO TECHNOLOGY, LLC, WILMINGTON, DE (US)

(21) Appl. No.: 12/247,443

(22) Filed: Oct. 8, 2008

(51) Int. Cl. H04N 5/445

(52) U.S. Cl. 725/45

(57) ABSTRACT

A system and method are disclosed for processing a video item to automatically provide or recommend bookmarks and bookmark headings for the video item. In one embodiment, the video item is first logically segmented into a number of segments. For each segment of the video item, a bookmark linking to a start of the segment of the video item is generated. In addition, audio and/or video content of each segment of the video item is processed in order to generate one or more recommended headings, or titles, for the corresponding bookmark. Information identifying the recommended bookmarks and bookmark headings may then be returned to an owner of the video item. The owner may then provide user input accepting, modifying, or rejecting the bookmarks and bookmark headings. Based on the user input from the owner, the bookmarks and bookmark headings for the video item are finalized and stored.

### FIELD OF THE INVENTION

The present invention relates to processing a video item to automatically provide or recommend bookmarks and bookmark headings for the video item.

### BACKGROUND OF THE INVENTION

Current video sharing services, such as YouTube, fail to provide a mechanism by which viewers can quickly and easily identify segments of shared video items of interest and then navigate to those segments of the shared video items. As such, there is a need for a system and method for an automatic process to generate bookmarks and bookmark headings for video items such that users may quickly and easily identify segments of the video items that are of interest and navigate to those segments during playback.

### SUMMARY OF THE INVENTION

The present invention relates to processing a video item to automatically provide or recommend bookmarks and bookmark headings for the video item. Preferably, the video item is a user-generated video item. In one embodiment, the video item is first logically segmented into a number of segments. For each segment of the video item, a bookmark linking to a start of the segment of the video item is generated. In addition, audio and/or video content of the each segment of the video item is processed in order to generate one or more recommended headings, or titles, for the corresponding bookmark. Information identifying the recommended bookmarks and bookmark headings may then be returned to an owner of the video item. The owner may then provide user input accepting, modifying, or rejecting the recommended bookmarks and bookmark headings. Based on the user input from the owner, the bookmarks and bookmark headings for the video item are finalized and stored.

In another embodiment, in addition to generating the recommended bookmarks and bookmark headings, one or more tags may be associated with each of the segments of the video item based on an analysis of the audio and/or video content of the segments of the video item. In one embodiment, the tags for each segment of the video item are provided in the form of a tag cloud. The recommended bookmarks, bookmark headings, and tag clouds may be returned to an owner of the video item. The owner may provide user input accepting, modifying, or rejecting the bookmarks, the bookmark headings, and the tag clouds. Based on the user input from the owner, the bookmarks, bookmark headings, and tag clouds for the video item are finalized.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system providing automatic bookmarks and bookmarks headings for video items according to one embodiment of the present invention;

FIG. 2 illustrates the operation of the system of FIG. 1 according to one embodiment of the present invention;

FIG. 3 is a flow chart illustrating a process for generating recommended bookmarks, recommended bookmark headings, and recommended tag clouds for a video item according to one embodiment of the present invention;

FIGS. 4A through 4C illustrate an exemplary Graphical User Interface (GUI) for presenting information identifying recommended bookmarks, recommended bookmark headings, and recommended tag clouds for a video item to an owner of the video item according to one embodiment of the present invention;

FIG. 5 is a block diagram of the central server of FIG. 1 according to one embodiment of the present invention; and

FIG. 6 is a block diagram of one of the user devices of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

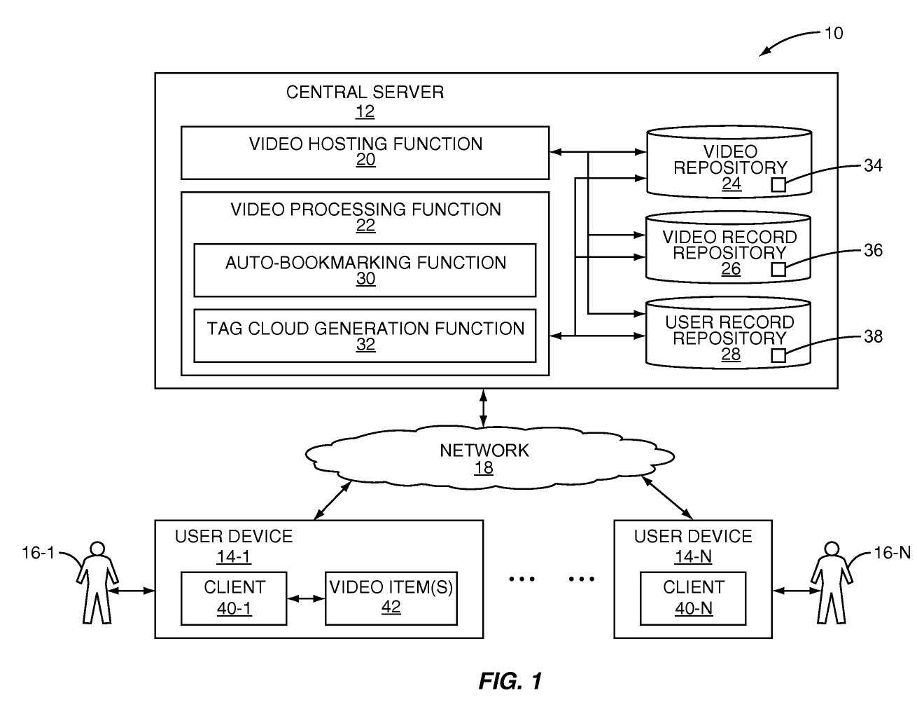

FIG. 1 illustrates a system 10 providing automatic bookmarks and bookmarks headings for video items according to one embodiment of the present invention. In general, the system 10 includes a central server 12 and a number of user devices 14-1 through 14-N having associated users 16-1 through 16-N. The central server 12 and the user devices 14-1 through 14-N are connected via a network 18. The network 18 may be any type of Wide Area Network (WAN), Local Area Network (LAN), the like, or any combination thereof. Further, the network 18 may include wired components, wireless components, or both wired and wireless components. As an example, the network 18 may be a global network, such as the Internet, where each of the user devices 14-1 through 14-N is connected to the network 18 via a wired connection such as an Ethernet connection to a cable modem or Digital Subscriber Line (DSL) modem; a local wireless connection such as an IEEE 802.11x connection to an access point; or a mobile connection provided by a mobile telephone service provider (e.g., a Global System for Mobile communications (GSM) connection, a third generation (3G) connection, or the like). As will be appreciated by one of ordinary skill in the art upon reading this disclosure, while FIG. 1 illustrates a single central server 12, the functionality of the central server 12 may be distributed among multiple servers for purposes of load-sharing and/or redundancy.

The central server 12 includes a video hosting function 20, a video processing function 22, a video repository 24, a video record repository 26, and a user record repository 28. The video hosting function 20 may be implemented in software, hardware, or a combination thereof. In general, the video hosting function 20 enables the users 16-1 through 16-N to upload video items to the central server 12 for storage in the video repository 24 and publish the video items for viewing by all of the other users 16-2 through 16-N or a limited subset of the other users 16-2 through 16-N. In addition, the video hosting function 20 delivers video items from the video repository 24 to the user devices 14-1 through 14-N upon request. In one embodiment, the video hosting function 20 operates in much the same manner as conventional video sharing services, such as YouTube.

The video processing function 22 may also be implemented in software, hardware, or a combination thereof. In general, the video processing function 22 includes an auto-bookmarking function 30 and a tag cloud generation function 32. For each video item of at least a subset of the video items in the video repository 24, the auto-bookmarking function 30 operates to logically divide the video item into a number of segments, generate bookmarks for the segments of the video item, and generate headings or titles for the bookmarks based on the audio and/or video content of the corresponding segments of the video item. In addition, for each segment of the video item, the tag cloud generation function 32 generates a tag cloud including one or more tags that are descriptive of the content of the corresponding segment of the video item.

The video repository 24 includes a number of video items 34 uploaded to the central server 12 from one or more of the user devices 14-1 through 14-N. Preferably, the video items 34 are user-generated video items created by one or more of the users 16-1 through 16-N. For example, the video items 34 may be video recordings captured by electronic video capture devices of one or more of the users 16-1 through 16-N. The video capture devices may be, for example, digital camcorders, digital cameras having video capture capabilities, mobile smart phones having video capture capabilities, web cameras, or the like. Note that while in the preferred embodiment the video items 34 are user-generated videos, the present invention is not limited thereto. Also note that while the video items 34 are referred to herein as “video items,” one of ordinary skill in the art will appreciate that the video items 34 include video content and, optionally, audio content.

The video record repository 26 includes a video record 36 for each of the video items 34 that has been processed by the video processing function 22. The video record 36 of one of the video items 34 includes information identifying the video item 34 such as, for example, a Uniform Resource Locator (URL) to the video item 34 in the video repository 24, an identifier (ID) assigned to the video item 34, or the like. In addition, the video record 36 includes a bookmark record (not shown) for each bookmark generated for the video item 34. Each bookmark record includes information defining the bookmark, or more specifically, information identifying a location in the video item 34 corresponding to the bookmark such as, for example, a time-offset from the beginning of the video item 34, a frame number or frame offset from the beginning of the video item 34, or the like. The bookmark record may also include information identifying an end point to the segment of the video item 34 starting at the bookmark. The bookmark record also includes a bookmark heading or title for the bookmark.

In addition to the information identifying the video item 34 and the bookmark records for the bookmarks generated for the video item 34, the video record 36 may include a tag cloud record for each segment of the video item 34. More specifically, in one embodiment, a tag cloud record (not shown) for a segment of the video item 34 includes information identifying the segment of the video item 34 such as, for example, information identifying the corresponding bookmark or bookmark record. In addition, the tag cloud record includes a list of tags in the tag cloud and, optionally, weights assigned to the tags in the tag cloud. Further, in one embodiment, the tags in the tag cloud are associated with additional bookmarks, or sub-bookmarks, within the corresponding segment of the video item 34. As such, for each tag in the tag cloud record, the tag cloud record may include information defining the sub-bookmark for the tag (e.g., a time offset, a frame number, a frame offset, or the like). Note that, in one embodiment, there may be multiple instances of content corresponding to a tag within the segment of the video item 34. As such, multiple sub-bookmarks may be defined for the tag.

The user record repository 28 includes a user record 38 for each of at least a subset of the users 16-1 through 16-N that have uploaded video items to the central server 12. Using the user 16-1 as an example, the user record 38 of the user 16-1 includes information identifying the user 16-1 such as, for example, a username of the user 16-1, an email address of the user 16-1, an Internet Protocol (IP) address of the user device 14-1 of the user 16-1, or the like. In addition, the user record 38 of the user 16-1 may include information identifying video items 34 in the video repository 24 uploaded, or owned, by the user 16-1. Still further, the user record 38 of the user 16-1 may include information identifying one or more preferences of the user 16-1. The preferences of the user 16-1 may include an aggressiveness preference which directly or indirectly controls a degree to which the video processing function 22 segments video items 34 uploaded by the user 16-1, the number of bookmarks for the video items 34 uploaded by the user 16-1, the number of recommended bookmark headings for each bookmark generated for the video items 34 uploaded by the user 16-1, the number of tags included in tag clouds generated for the video items 34 uploaded by the user 16-1, or any combination thereof. The preferences of the user 16-1 may additionally or alternatively include one or more bookmark preferences such as a desired bookmark type. The desired bookmark type may be, for example, a name or names of persons appearing in the bookmarked segment of the video item 34 or text that is descriptive of the content of the bookmarked segment of the video item 34 uploaded by the user 16-1.

The user record 38 of the user 16-1 may also include information identifying a number of other users from the users 16-2 through 16-N that are in a social network of the user 16-1, or information referencing one or more social networks of the user 16-1 hosted by third-party social networking services such as, for example, MySpace, Facebook, LinedIN, America Online Instant Messenger (AIM), or the like. Lastly, as discussed below, the user record 38 of the user 16-1 may include a navigational bookmark and tag dictionary used for generating bookmark headings and tags for segments of video items 34 uploaded by the user 16-1.

The user devices 14-1 through 14-N may each be, for example, a personal computer, a mobile smart phone, a portable media player having network capabilities, or the like. In general, the user devices 14-1 through 14-N include clients 40-1 through 40-N, respectively. The clients 40-1 through 40-N generally enable the users 16-1 through 16-N to interact with the central sever 12 in order to upload video items 34; review recommended bookmarks, bookmark headings, and a tag clouds generated by the video processing function 22 for uploaded video items 34; view video items 34 hosted by the central server 12; or the like. The clients 40-1 through 40-N may be implemented in software, hardware, or a combination thereof. In one embodiment, the clients 40-1 through 40-N are web browsers. However, the present invention is not limited thereto. In addition, as illustrated with respect to the user device 14-1 of the user 16-1, at least some of the user devices 14-1 through 14-N store video items 42. Thus, using the user 16-1 as an example, the user 16-1 may select one or more of the video items 42 stored locally at the user device 14-1 for upload to the central server 12.

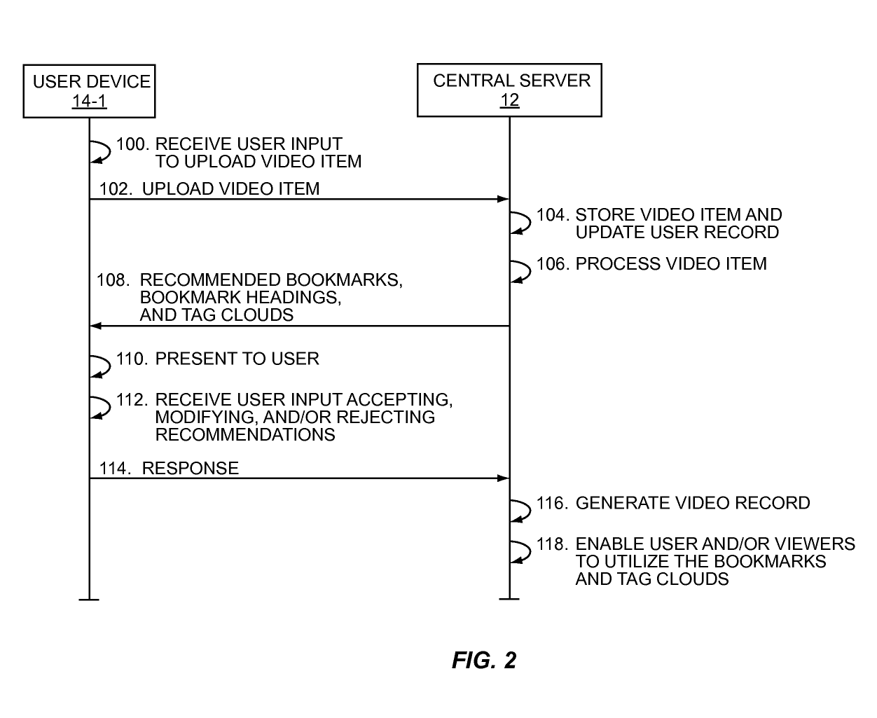

FIG. 2 illustrates the operation of the system 10 of FIG. 1 according to one embodiment of the present invention. First, the client 40-1 of the user device 14-1 receives user input to upload a video item 42 from the user device 14-1 to the central server 12 (step 100). In response, the client 40-1 of the user device 14-1 uploads the video item 42 to the central server 12 (step 102). At the central server 12, the video hosting function 20 receives the video item 42 from the user device 14-1, stores the video item 42 in the video repository 24 as one of the video items 34 hosted by the central server 12, and updates the user record of the user 16-1 (step 104). In this example, the video processing function 22 thereafter processes the video item 34 uploaded from the user device 14-1 to segment the video item into multiple logical segments, generate a recommended bookmark for each of the segments, generate one or more recommended headings for each of the bookmarks, and optionally recommend one or more tags for each of the segments in the form of, in this example, a tag cloud (step 106). Note that the recommended tags are not required to be in the form of a tag cloud.

Once the video item 34 has been processed, the video processing function 22, or alternatively the video hosting function 20, of the central server 12 sends information identifying the recommended bookmarks, the recommended bookmark headings, and the recommended tag clouds for the segments of the video item 34 to the user device 14-1 (step 108). The recommended bookmarks, the recommended bookmark headings, and the recommended tag clouds for the segments of the video item 34 are then presented to the user 16-1 (step 110). More specifically, in one embodiment, a notification that processing of the video item 34 is complete is provided to the user 16-1 via an email message, a text-message, or the like. The notification may include, for example, a reference, such as a URL, to a web page or similar resource illustrating the recommended bookmarks, the recommended headings for the bookmarks, and optionally the recommended tag clouds associated with the bookmarked segments of the video item 34. In another embodiment, a notification that processing of the video item 34 is complete is provided to the user 16-1. The user 16-1 may then access the video hosting function 20, or alternatively the video processing function 22, via the client 40-1 to view the recommended bookmarks, the recommended headings for the bookmarks, and optionally the recommended tag clouds associated with the bookmarked segments of the video item 34.

Once the recommended bookmarks, the recommended bookmark headings, and the recommended tag clouds for the segments of the video item 34 are presented to the user 16-1, the client 40-1 of the user device 14-1 receives user input from the user 16-1 accepting, modifying, or rejecting the recommended bookmarks, recommended bookmark headings, and the recommended tag clouds for the segments of the video item 34 (step 112). Note that the user 16-1 may accept some or all of the recommendations, modify some or all of the recommendations, and/or reject some or all of the recommendations. The client 40-1 of the user device 14-1 then sends the user input from the user 16-1 to the central server 12 (step 114). Based on the user input of the user 16-1, the video processing function 22, or alternatively the video hosting function 20, generates a video record 36 for the video item 34 (step 116). As discussed above, the video record 36 includes information defining the bookmarks for the video item 34, the headings for the bookmarks, and the tag clouds associated with the segments or bookmarks of the video item 34.

Thereafter, the video hosting function 20 of the central server 12 enables the user 16-1 and/or the other users 16-2 through 16-N to utilize the bookmarks and tag clouds for the video item 34 uploaded from the user device 14-1 (step 118). There are numerous manners in which the bookmarks and tag clouds may be utilized. First, with respect to the user 16-1, the user 16-1 may be enabled to use the bookmarks as navigational controls when viewing the video item 34. The bookmark headings enable the user 16-1 to quickly and easily identify segments of the video item 34 of interest and skip to those segments of interest during playback. In addition, the tag clouds may be viewable by the user 16-1 such that the user 16-1 is enabled to quickly view additional descriptive information regarding the content of the bookmarked segments of the video item 34. Further, in one embodiment, the tags in the tag clouds may also be associated with additional bookmarks, or sub-bookmarks, within the corresponding segments of the video item 34. As such, by selecting a particular tag associated with a segment of the video item 34, the user 16-1 may be enabled to jump to a location in playback of the video item 34 corresponding to that particular tag. In a similar manner, the bookmarks and tags may be used by the other users 16-2 through 16-N while viewing the video item 34.

In addition, the user 16-1 may be enabled to send a reference to a particular bookmark of the video item 34 to the other users 16-2 through 16-N. The reference may be sent via a communication service provided by the video hosting function 20, email, text-messaging, or the like. Using the reference, the recipients may obtain the video item 34 from the video hosting function 20 of the central server 12 with playback beginning at the particular bookmark of the video item 34 rather than at the beginning of the video item 34. In one embodiment, the reference is a URL to the video item 34 hosted by the central server 12 that includes the bookmark heading of the bookmark for the video item 34. As such, upon receiving a request for the URL including the bookmark heading, the video hosting function 20 may first access the video record 36 for the video item 34 to obtain the information defining the bookmark (e.g., a time-offset, a frame number, a frame-offset, or the like) having the provided bookmark heading. The video hosting function 20 may then begin streaming the video item 34 to the user device of the recipient starting at the location in the video item 34 identified by the bookmark. Alternatively, rather than including the bookmark heading, the URL may include the information defining the bookmark (e.g., a time-offset, a frame number, a frame-offset, or the like). Likewise, the other users 16-2 through 16-N may also be enabled to send references to desired bookmarked segments of the video item 34 to other users.

Still further, the bookmark headings and tag clouds may be used when processing keyword search requests from the users 16-1 through 16-N. More specifically, in one embodiment, the video hosting function 20 includes a search engine that enables the users 16-1 through 16-N to search the video repository 24 for video items 34 of interest. Thus, upon receiving a search request including one or more keyword search terms, the search engine may search the video record repository 26 to identify video items 34 in the video repository 24 that have bookmark headings and/or tags satisfying the one or more keyword search terms. Then, rather than simply returning references to the identified video items 34, the search engine of the video hosting function 20 may return references to the bookmarks of the identified video items 34 having bookmark headings that satisfy the one or more keyword search terms, references to bookmarks of segments of the identified video items 34 having associated tags satisfying the one or more keyword search terms, or both.

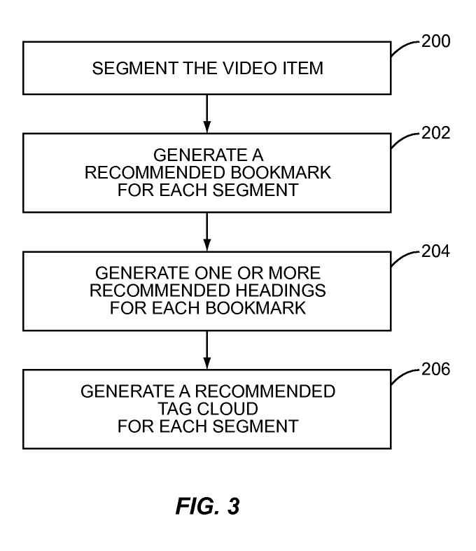

FIG. 3 is a flow chart illustrating the video processing step (step 106) of FIG. 2 in more detail according to one embodiment of the present invention. First, the video processing function 22 segments the video item 34 into multiple video segments (step 200). More specifically, in one embodiment, after a user has uploaded a video item 34 to the central server 12, the video processing function 22 obtains the video item 34 from the video repository 24. Note that due to the number of uploaded video items 34, scheduling may be used to schedule the video items 34 for processing by the video processing function 22. The auto-bookmarking function 30 of the video processing function 22 then segments the video item 34 into multiple segments using any desired video segmentation technique. In one embodiment, the auto-bookmarking function 30 analyzes the video content and/or the audio content of the video item 34 to detect scene transitions. Each detected scene transition may then be identified as the end of one segment and the beginning of another segment of the video item 34. Adjacent scenes may be merged based on an analysis of the audio and/or video content of the video item 34 such that related scenes are merged into a single segment.

Once the segments are identified, the auto-bookmarking function 30 generates a recommended bookmark for each of the segments of the video item 34 (step 202). The recommended bookmark for a segment preferably identifies a starting point of that segment. The auto-bookmarking function 30 also generates one or more recommended headings, or titles, for each of the bookmarks (step 204). More specifically, in one embodiment, for each segment of the video item 34, the auto-bookmarking function 30 analyzes the audio and/or video content of the segment of the video item 34 to generate one or more recommended bookmark headings for the segment of the video item 34. For example, the auto-bookmarking function 30 may perform speech-to-text conversion on the audio content of a segment of the video item 34. Then, based on the resulting text, the auto-bookmarking function 30 may determine one or more activities occurring during the segment of the video item 34. Text describing or otherwise related to the one or more activities may then be provided as recommended headings for the bookmark for the segment of the video item 34.

As another example, speech-to-text conversion may be performed in order to identify names of persons spoken during the segment of the video item 34. More specifically, in one embodiment, the auto-bookmarking function 30 may search the text resulting from the speech-to-text conversion for names of persons in a social network of the owner of the video item 34. In addition or alternatively, the video content of the segment of the video item 34 may be processed to perform facial recognition to identify persons appearing in the segment of the video item 34. More specifically, in one embodiment, the auto-bookmarking function 30 may perform facial recognition to identity persons from a social network of the owner of the video item 34 that appear during the segment of the video item 34. The name or names of persons mentioned in the segment of the video item 34 and/or appearing in the segment of the video item 34 may then be provided as or included in one or more recommended headings for the bookmark for the segment of the video item 34. In addition or alternatively, the name or names of persons spoken and/or appearing during the segment of the video item 34 may be combined with one or more topics determined as discussed above in order to provide one or more recommended headings for the bookmark for the segment of the video item 34.

Note that when analyzing the segments of the video item 34, cues detected in the audio content may be cross-referenced with cues detected in the video content and vice versa. For example, if a person's name is detected in the audio content, the auto-bookmarking function 30 may determine whether the face of that person is detected in the video content before using the name of that person as a recommended bookmark heading or as part of a recommended bookmark heading.

In order to assist the auto-bookmarking function 30 in generating recommended bookmark headings, a bookmark and tag dictionary may be populated or maintained for the owner of the video item 34. The bookmark and tag dictionary may include bookmark headings used for other video items 34 uploaded by the owner of the video item 34, bookmark headings previously recommended to the owner of the video item 34 for other video items 34 uploaded by the owner of the video item 34, bookmark headings used by or recommended to other users in a social network of the owner of the video item 34, bookmark headings used by or recommended to other users for video items 34 in the video repository 24 that have audio and/or video content similar to that of the video item 34, bookmark headings used by or recommended to other users that are similar to the owner of the video item 34 (e.g., similar demographics), bookmarks of video items 34 previously viewed by the owner of the video item 34, bookmarks previously selected by the owner of the video item 34 during playback of other video items 34, the like, or any combination thereof. Further, weights may be assigned to the bookmark headings in the bookmark and tag dictionary based on, for example, frequency of use, whether the bookmark heading was used or only recommended, or the like. Then, based on the analysis of the audio and/or video content of the segment of the video item 34, one or more bookmark headings from the bookmark and tag dictionary may be identified as recommended bookmark headings for the bookmark for the segment of the video item 34. Note that bookmark headings in the bookmark and tag dictionary that have higher weights may be given priority.

Further, the preferences of the owner of the video item 34 may define a desired bookmark heading type. The desired bookmark heading type may be, for example, the name or names of persons appearing in the corresponding segment of the video item 34 (e.g., “Jan and Jen”) or text describing activities occurring during the corresponding segment of the video item 34 (e.g., “Congratulatory Toast”). As such, the desired bookmark heading type may be taken into account when generating the recommended bookmark headings.

In this embodiment, in addition to generating the recommended bookmarks and recommended bookmark headings, the video processing function 22 generates a recommended tag cloud for each segment of the video item 34 (step 206). Note that step 206 is optional and is not necessary for the present invention. More specifically, for each segment of the video item 34, the tag cloud generation function 32 analyzes the audio and/or video content of the video item 34 to identify one or more tags, or keywords, descriptive of the content of the segment of the video item 34. The tags may include, for example, names of persons appearing in the segment of the video item 34, names of persons spoken during the segment of the video item 34, or both. In one embodiment, the audio and/or video content of the segment of the video item 34 is analyzed to identify the names of persons from a social network of the owner of the video item 34 that appear in the segment of the video item 34 and/or names of persons from a social network of the owner of the video item 34 that are spoken during the segment of the video item 34.

In addition or alternatively, the tags may include keywords corresponding to or otherwise related to words spoken during the segment of the video item 34, activities occurring during the segment of the video item 34, or both. For example, if the content of the segment of the video item 34 is fireworks on the beach during a 4th of July vacation, the tags may include “Beach,” “Fireworks,” and “Cheering.” Note that the “Beach” tag may be generated in response to, for example, detecting the word “beach” or “ocean” spoken during the segment of the video item 34 and/or detecting the sound of the ocean in the audio content of the video item 34. Similarly, the “Fireworks” tag may be generated in response to detecting fireworks in the segment of the video content of the video item 34 and/or detecting the sound of fireworks in the audio content of the segment of the video item 34, and/or the tag “Cheering” may be generated in response to detecting the sound of cheering in the audio content of the segment of the video item 34. Also, in one embodiment, the tags may be influenced by a date and/or time at which the video item 34 was recorded or otherwise created. For example, if the video item 34 was created on July 4, 2008, then the recommended tags, or a pool of tags from which the recommended tags are selected, may include common tags associated with the 4th of July such as, for example, “Fireworks,” “Party,” or the like.

Again, in order to assist the auto-bookmarking function 30 in generating recommended tags, a bookmark and tag dictionary may be populated or maintained for the owner of the video item 34. The bookmark and tag dictionary may include tags used for other video items 34 uploaded by the owner of the video item 34, tags previously recommended to the owner of the video item 34 for other video items 34 uploaded by the owner of the video item 34, tags used by or recommended to other users in a social network of the owner of the video item 34, tags used by or recommended to other users for video items 34 in the video repository 24 that have audio and/or video content similar to that of the video item 34, tags used by or recommended to other users that are similar to the owner of the video item 34 (e.g., similar demographics), tags of video items 34 previously viewed by the owner of the video item 34, tags previously selected by the owner of the video item 34 during playback of other video items 34, the like, or any combination thereof. Further, weights may be assigned to the tags in the bookmark and tag dictionary based on, for example, frequency of use, whether the tags were used or only recommended, or the like. Then, based on the analysis of the audio and/or video content of the segment of the video item 34, one or more tags from the bookmark and tag dictionary may be identified as recommended tags for the tag cloud for the segment of the video item 34. Note that tags in the bookmark and tag dictionary that have higher weights may be given priority.

For each segment of the video item 34, the tags identified by the tag cloud generation function 32 are then combined to form a tag cloud for the segment of the video item 34. In one embodiment, a size of each tag in the tag cloud corresponds to the relevancy of the tag with respect to the segment of the video item 34. The relevancy of a tag may be a function of the weight assigned to the tag in the bookmark and tag dictionary of the owner of the video item 34, the number of content instances within the segment of the video item 34 related to the tag, or the like. For example, if the sound of fireworks is heard frequently during the segment of the video item 34, then the tag “Fireworks” may be determined to have a high relevancy and therefore be given a relatively large size within the tag cloud.

Further, in order to control the number of tags in a tag cloud for a segment of the video item 34, the tags identified for the segment of the video item 34 may be pruned and/or collapsed. For instance, the least relevant tags may not be included in the tag cloud such that the tag cloud includes at most a predetermined maximum number of tags. As for collapsing tags, related tags may be collapsed into a single generic tag using an ontology or similar data structure defining relationships between keywords or terms. For example, a “baseball” tag and a “football” tag may be collapsed into a “sports” tag.

The video processing function 22 may consider an aggressiveness preference of the owner of the video item 34. More specifically, the aggressiveness preference set by the owner of the video item 34 may directly or indirectly affect the number of segments into which the video item 34 is divided and thus the number of recommended bookmarks generated, the number of recommended bookmark headings generated for each of the bookmarks, and/or the number of tags generated in the tag clouds for the segments of the video item 34. The higher the aggressiveness, the higher the number of segments into which the video item 34 is divided and thus the higher the number of recommended bookmarks generated, the higher the number of recommended bookmark headings generated for each of the bookmarks, and/or the higher the number of tags generated in the tag clouds for the segments of the video item 34.

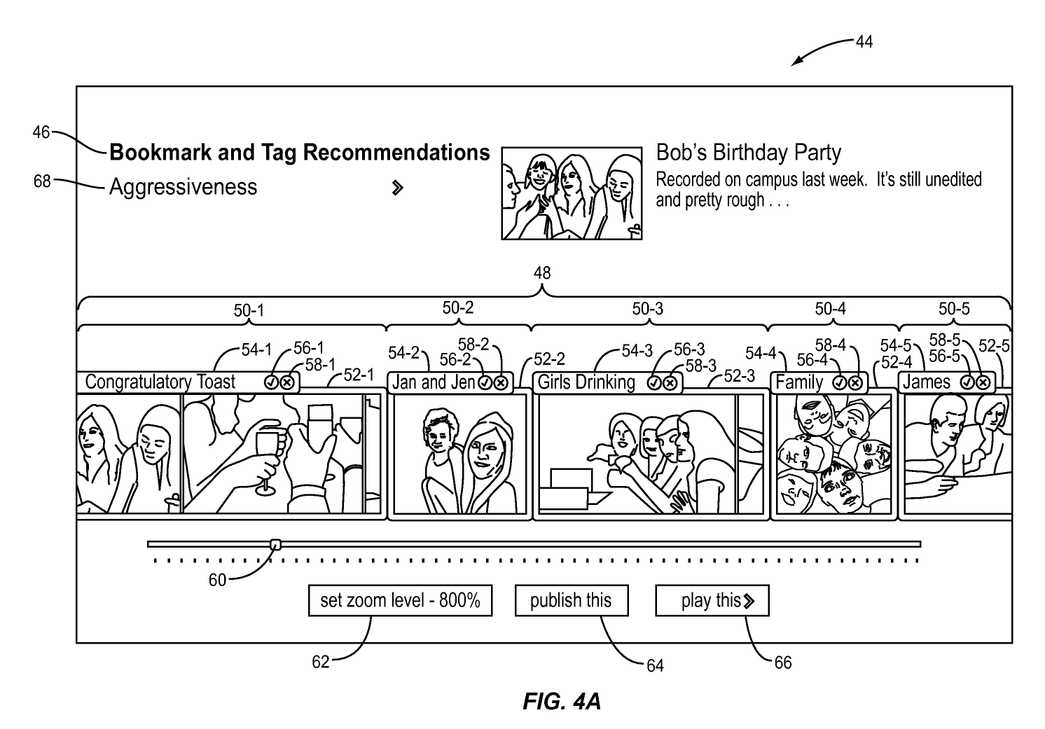

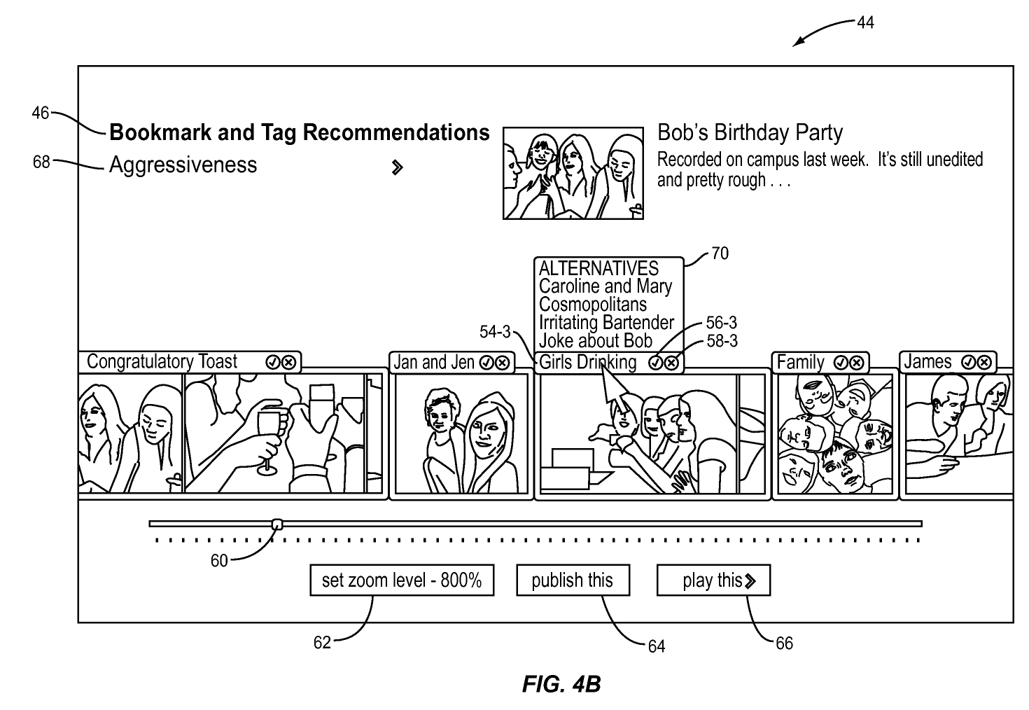

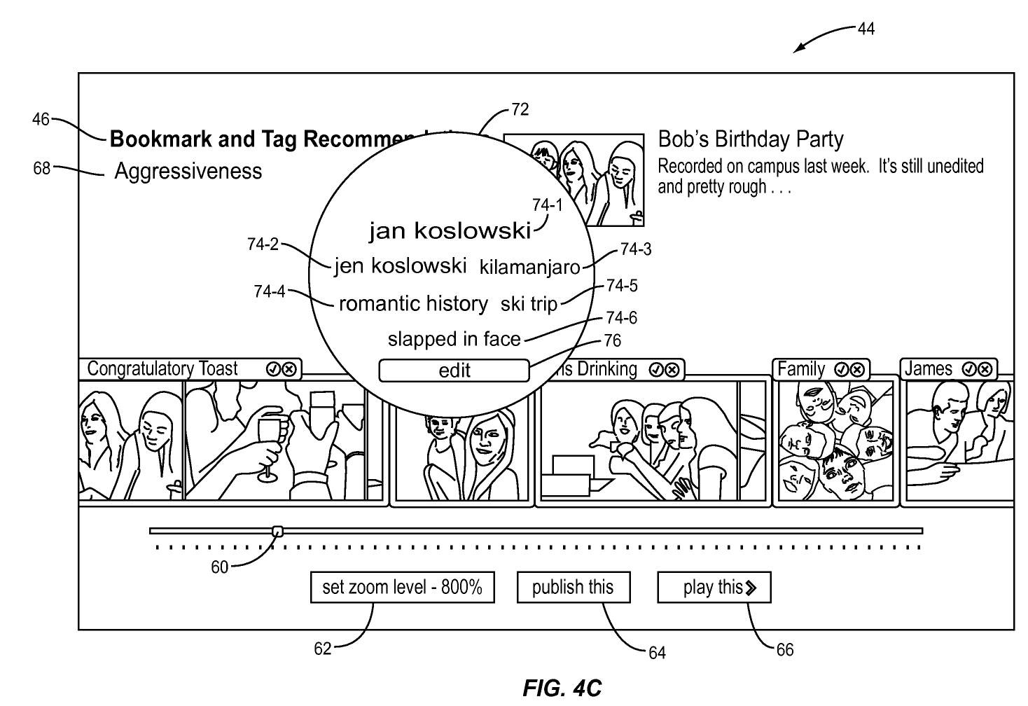

FIGS. 4A through 4C illustrate an exemplary Graphical User Interface (GUI) 44 for presenting recommended bookmarks, recommended bookmark headings, and recommended tag clouds for a video item to the owner of the video item according to one embodiment of the present invention. As illustrated in FIG. 4A, by selecting a bookmarks and tag recommendations identifier 46, the GUI 44 presents a timeline 48 illustrating at least a portion of the video item. In this example, the timeline 48 includes a sequence of key frames of the video item. However, the present invention is not limited thereto. The GUI 44 also identifies segments 50-1 through 50-5 of the video item within the timeline 48 using rectangular indicators 52-1 through 52-5, respectively. By selecting and dragging the left or right edge of, for example, the rectangular indicator 52-1, the owner of the video item may adjust the starting point or ending point, respectively, of the segment 50-1. Note that by adjusting the left edge of, for example, the rectangular indicator 52-1, the owner of the video item adjusts the starting point of the segment 50-1, and thus the position of the bookmark for the segment 50-1.

The GUI 44 also presents recommended bookmark headings 54-1 through 54-5 in association with the segments 50-1 through 50-5, respectively. As discussed below, the owner of the video item may hover over or otherwise select the recommended bookmark headings 54-1 through 54-5 to view and, if desired, select other recommended bookmark headings for the corresponding bookmarks. The owner of the video item is enabled to accept the recommended bookmark headings 54-1 through 54-5 by selecting corresponding select buttons 56-1 through 56-5 or reject the recommended bookmark headings 54-1 through 54-5 by selecting corresponding reject buttons 58-1 through 58-5.

In this example, the GUI 44 also includes a slider bar 60 and buttons 62 through 66. Via the slider bar 60, the owner of the video item is enabled to move forward or backward in order to change which segments of the video item are shown in the timeline 48. The set zoom level button 62 enables the owner of the video item to adjust the zoom level for the timeline 48. As the zoom level increases, more key frames of the video item are shown for each segment, thereby reducing the number of segments shown in the timeline 48 at any one time. Conversely, if the zoom level decreases, less key frames of the video item are shown for each segment, thereby increasing the number of segments shown in the timeline 48 at any one time. The publish button 64 enables the owner of the video item to publish the video item after the owner of the video item has made any desired changes to the segments, accepted desired bookmarks and bookmark headings, and made any desired changes to the tag clouds for each of the segments. Note that by selecting the publish button 64 upon initially accessing the GUI 44, the owner of the video item is enabled to accept all of the recommendations of the video processing function 22 via a one click or single-click process. The play button 66 enables the owner of the video item to play the video item if desired. In this example, the GUI 44 also includes an aggressiveness identifier 68, which may be selected by the owner of the video item in order to adjust the aggressiveness preference of the owner of the video item for receiving bookmark and tag recommendations.

As illustrated in FIG. 4B, in this example, in response to hovering over the recommended bookmark heading 54-3, a list of additional recommended bookmark headings 70 is presented to the owner of the video item. If desired, the owner of the video item may then select one of the recommended bookmark headings from the list of additional recommended bookmark headings 70 as the bookmark heading 54-3. Once the desired bookmark heading 54-3 is selected, the owner of the video item may then accept the bookmark heading 54-3 by selecting the accept button 56-3. Note that the keyframe(s) for the segment 50-3 may or may not change in response to the owner of the video item changing the bookmark heading 54-3. In one embodiment, the keyframe(s) for the segment 50-3 do not change. In another embodiment, the keyframe(s) for the segment 50-3 change such that new keyframe(s) for the segment 50-3 are presented that more accurately correspond to the selected bookmark heading 54-3.

As illustrated in FIG. 4C, in this example, by selecting the bookmark heading 54-2, a tag cloud 72 for the corresponding segment 50-2 of the video item is presented to the owner of the video item. The tag cloud 72 includes a number of tags 74-1 through 74-6. Further, in this example, the sizes of the tags 74-1 through 74-6 reflect the relevance of the tags 74-1 through 74-6 to the segment 50-2 of the video item. In this example, the owner of the video item may edit the tags 74-1 through 74-6 in the tag cloud 72 by selecting an edit button 76. In response to selecting the edit button 76, the GUI 44 may enable the owner of the video item to delete one or more of the tags 74-1 through 74-6 from the tag cloud 72, modify one or more of the tags 74-1 through 74-6 in the tag cloud 72, modify the size and thus relevance of the tags 74-1 through 74-6 in the tag cloud 72, or add one or more new tags to the tag cloud 72. In addition, if the tags 74-1 through 74-6 serve as sub-bookmarks for the segment 50-2 of the video item, the owner of the video item may also be enabled to modify the positions of the sub-bookmarks within the segment 50-2 of the video item.

Note that in one embodiment, the tags 74-1 through 74-6 are each associated with one or more sub-bookmarks within the segment 50-2 of the video item. For example, if “jan koslowski” appears in the segment 50-2 of the video item at three (3) different positions, then the tag 74-1 may be associated with three (3) sub-bookmarks. As such, when the tag 74-1 is thereafter selected by the owner of the video item or some other viewer as a navigational control, the three (3) sub-bookmarks may be presented to the owner of the video item or other viewer. The owner of the video item or other viewer may then select one of the sub-bookmarks such that playback jumps to the selected sub-bookmark. Alternatively, if the tag 74-1 is associated with only one bookmark, the owner of the video item or other viewer may select the tag 74-1 such that playback immediately jumps to the associated sub-bookmark.

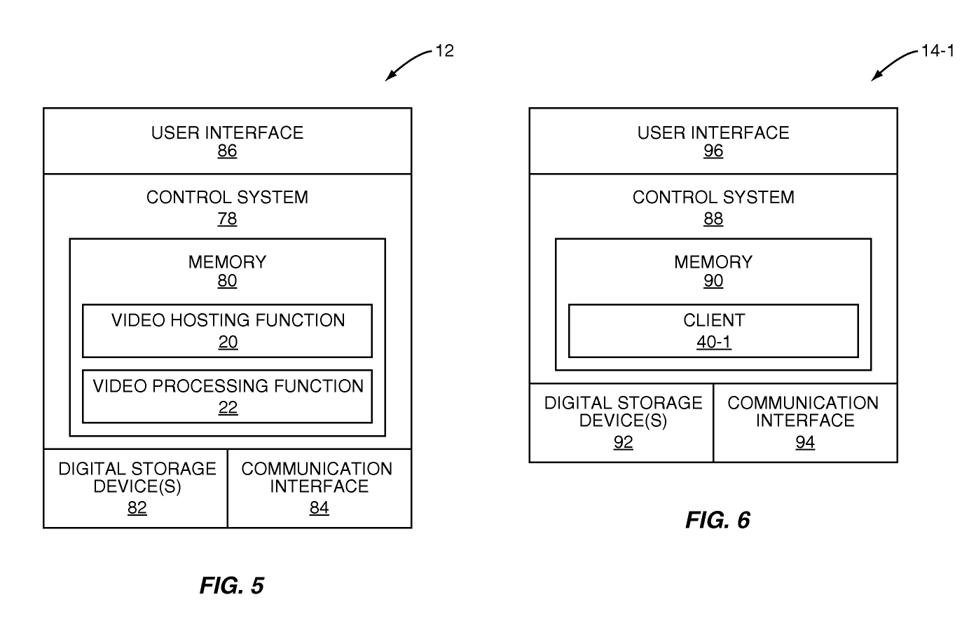

FIG. 5 is a block diagram of the central server 12 of FIG. 1 according to one embodiment of the present invention. In general, the central server 12 includes a control system 78 having associated memory 80. In this example, the video hosting function 20 and the video processing function 22 are implemented in software and stored in the memory 80. However, the present invention is not limited thereto. The video hosting function 20 and the video processing function 22 may each be implemented in software, hardware, or a combination thereof. The central server 12 also includes one or more digital storage devices 82, such as one or more hard disk drives or the like. In one embodiment, the video repository 24, the video record repository 26, and the user record repository 28 (FIG. 1) may be stored in the one or more digital storage devices 82. Alternatively, the video repository 24, the video record repository 26, and/or the user record repository 28 may be stored in one or more external storage devices associated with the central server 12. The central server 12 also includes a communication interface 84 communicatively coupling the central server 12 to the network 18 (FIG. 1). Lastly, the central server 12 includes a user interface 86, which may include components such as, for example, a display, one or more user input devices, or the like.

FIG. 6 is a block diagram of the user device 14-1 of FIG. 1 according to one embodiment of the present invention. This discussion is equally applicable to the other user devices 14-2 through 14-N. In general, the user device 14-1 includes a control system 88 having associated memory 90. In this example, the client 40-1 is implemented in software and stored in the memory 90. However, the present invention is not limited thereto. The client 40-1 may be implemented in software, hardware, or a combination thereof. The user device 14-1 may also include one or more digital storage devices 92. In one embodiment, the one or more video items 42 (FIG. 1) of the user 16-1 are stored in the one or more digital storage devices 92. Alternatively, the one or more video items 42 may be stored in the memory 90. The user device 14-1 also includes a communication interface 94 communicatively coupling the user device 14-1 to the network 18 (FIG. 1). The communication interface 94 may be a wired communication interface such as, for example, an Ethernet connection; a local wireless communication interface such as, for example, an IEEE 802.11x wireless communication interface; or a mobile communication interface such as, for example, a GSM or 3G communication interface. Lastly, the user device 14-1 includes a user interface 96, which includes components such as, for example, a display, one or more speakers, one or more user input devices, or the like.

The present invention provides substantial opportunity for variation. For example, while the discussion above focuses on the embodiment illustrated in FIG. 1, the present invention is not limited thereto. In another embodiment, the video processing function 22 may be implemented on a user device such as, for example, a personal computer of a user in order to provide automatic bookmarks, bookmark headings, and optionally tag clouds for video items in a video collection stored by the user device. As another example, while the discussion above focuses on video items, the present invention is not limited thereto. The present invention is also applicable to other types of media items such as audio items. For example, the auto-bookmarking and tag cloud generation process may be performed for an audio recording, such as a speech or a lecture.

Those skilled in the art will recognize improvements and modifications to the preferred embodiments of the present invention. All such improvements and modifications are considered within the scope of the concepts disclosed herein and the claims that follow.

What is claimed is:

1. A method comprising:
obtaining a video item;
automatically providing a plurality of recommended bookmarks and a plurality of recommended bookmark headings for the video item based on an analysis of at least one of a group consisting of: audio content of the video item and video content of the video item; and
returning information identifying the plurality of recommended bookmarks and the plurality of recommended bookmark headings to an owner of the video item.

2. The method of claim 1 wherein automatically providing the plurality of recommended bookmarks and the plurality of recommended bookmark headings for the video item comprises:
identifying a plurality of recommended segments of the video item based on an analysis of at least one of a group consisting of: the audio content of the video item and the video content of the video item; and
for each recommended segment of the plurality of recommended segments of the video item:
automatically generating a recommended bookmark of the plurality of recommended bookmarks corresponding to a starting point of the recommended segment; and
automatically providing one or more recommended bookmark headings of the plurality of recommended bookmark headings for the recommended bookmark based on an analysis of at least one of a group consisting of: audio content of the recommended segment of the video item and video content of the recommended segment of the video item.

3. The method of claim 2 wherein for each recommended segment of the plurality of recommended segments, the one or more recommended bookmark headings for the recommended bookmark for the recommended segment are descriptive of at least one of the group consisting of: the audio content of the recommended segment of the video item and the video content of the recommended segment of the video item.

4. The method of claim 2 wherein for each recommended segment of at least one of the plurality of recommended segments, and automatically providing the one or more recommended bookmark headings comprises:
analyzing at least one of the group consisting of: the audio content of the recommended segment of the video item and the video content of the recommended segment of the video item to identify one or more persons appearing in the recommended segment of the video item; and
including a name of at least one of the one or more persons in at least one of the one or more recommended bookmark headings.

5. The method of claim 2 wherein for each recommended segment of at least one of the plurality of recommended segments, and automatically providing the one or more recommended bookmark headings comprises:
analyzing at least the audio content of the recommended segment of the video item to identify one or more names of one or more corresponding persons spoken during the recommended segment of the video item; and
including at least one of the one or more names in at least one of the one or more recommended bookmark headings.

6. The method of claim 2 wherein for each recommended segment of at least one of the plurality of recommended segments, and automatically providing the one or more recommended bookmark headings comprises:
analyzing at least one of the group consisting of: the audio content of the recommended segment of the video item and the video content of the recommended segment of the video item to identify one or more activities occurring during the recommended segment of the video item; and
including one or more terms descriptive of at least one of the one or more activities in at least one of the one or more recommended bookmark headings.

7. The method of claim 2 wherein for at least one of the plurality of recommended segments, automatically providing the one or more recommended bookmark headings for the recommended bookmark for the at least one of the plurality of recommended segments comprises selecting a bookmark heading from a plurality of predetermined bookmark headings based on an analysis of at least one of a group consisting of: audio content of the at least one of the plurality of recommended segments and video content of the at least one of the plurality of recommended segments.

8. The method of claim 7 wherein the plurality of predetermined bookmark headings comprise at least one bookmark heading for at least one other video item associated with the owner of the video item.

9. The method of claim 7 wherein the plurality of predetermined bookmark headings comprise at least one bookmark heading previously recommended to the owner of the video item for at least one other video item.

10. The method of claim 7 wherein the plurality of predetermined bookmark headings comprise at least one bookmark heading for at least one other video item of at least one user in a social network of the owner of the video item.

11. The method of claim 7 wherein the plurality of predetermined bookmark headings comprise at least one bookmark heading recommended to at least one user in a social network of the owner of the video item.

12. The method of claim 7 wherein the plurality of predetermined bookmark headings comprise at least one bookmark heading for at least one other video item having content similar to that of the video item.

13. The method of claim 7 wherein the plurality of predetermined bookmark headings comprise at least one bookmark heading recommended for at least one other video item having content similar to that of the video item.

14. The method of claim 7 wherein the plurality of predetermined bookmark headings comprise at least one bookmark heading for at least one other video item of a user that is similar to the owner of the video item.

15. The method of claim 7 wherein the plurality of predetermined bookmark headings comprise at least one bookmark heading recommended to a user that is similar to the owner of the video item.

16. The method of claim 7 wherein the plurality of predetermined bookmark headings comprise at least one bookmark heading of another video item previously viewed by the owner of the video item.

17. The method of claim 7 wherein the plurality of predetermined bookmark headings comprise at least one bookmark heading selected by the owner of the video item during playback of another video item.

18. The method of claim 2 further comprising for each recommended segment of the plurality of recommended segments, generating a tag cloud for the recommended segment comprising one or more tags that are descriptive of at least one of the group consisting of: audio content of the recommended segment of the video item and video content of the recommended segment of the video item.

19. The method of claim 18 wherein for each recommended segment of at least one of the plurality of recommended segments, and generating the tag cloud for the recommended segment comprises:
analyzing at least one of the group consisting of: the audio content of the recommended segment of the video item and the video content of the recommended segment of the video item to identify one or more persons appearing in the recommended segment of the video item; and
providing a name of at least one of the one or more persons as one of the one or more tags in the tag cloud.

20. The method of claim 18 wherein for each recommended segment of at least one of the plurality of recommended segments, and generating the tag cloud for the recommended segment comprises:
analyzing at least the audio content of the recommended segment of the video item to identify one or more names of one or more corresponding persons spoken during the recommended segment of the video item; and
providing at least one of the one or more names as at least one corresponding tag of the one or more tags in the tag cloud.

21. The method of claim 18 wherein for each recommended segment of at least one of the plurality of recommended segments, and generating the tag cloud for the recommended segment comprises:
analyzing at least one of the group consisting of: the audio content of the recommended segment of the video item and the video content of the recommended segment of the video item to identify one or more activities occurring during the recommended segment of the video item; and
providing one or more terms descriptive of at least one of the one or more activities as one or more corresponding tags of the one or more tags in the tag cloud.

22. The method of claim 18 wherein each of the one or more tags in the tag cloud is associated with one or more sub-bookmarks within the recommended segment of the video item.

23. The method of claim 18 wherein for at least one of the plurality of recommended segments, generating the tag cloud for the at least one of the plurality of recommended segments comprises selecting one or more tags from a plurality of predetermined tags based on an analysis of at least one of the group consisting of: audio content of the at least one of the plurality of recommended segments and video content of the at least one of the plurality of recommended segments.

24. The method of claim 23 wherein the plurality of predetermined tags comprise at least one tag for at least one other video item associated with the owner of the video item.

25. The method of claim 23 wherein the plurality of predetermined tags comprise at least one tag previously recommended to the owner of the video item for at least one other video item.

26. The method of claim 23 wherein the plurality of predetermined tags comprise at least one tag for at least one other video item of at least one user in a social network of the owner of the video item.

27. The method of claim 23 wherein the plurality of predetermined tags comprise at least one tag recommended to at least one user in a social network of the owner of the video item.

28. The method of claim 23 wherein the plurality of predetermined tags comprise at least one tag for at least one other video item having content similar to that of the video item.

29. The method of claim 23 wherein the plurality of predetermined tags comprise at least one tag recommended for at least one other video item having content similar to that of the video item.

30. The method of claim 23 wherein the plurality of predetermined tags comprise at least one tag for at least one other video item of a user that is similar to the owner of the video item.

31. The method of claim 23 wherein the plurality of predetermined tags comprise at least one tag recommended to a user that is similar to the owner of the video item.

32. The method of claim 23 wherein the plurality of predetermined tags comprise at least one tag of another video item previously viewed by the owner of the video item.

33. The method of claim 23 wherein the plurality of predetermined tags comprise at least one tag selected by the owner of the video item during playback of another video item.

34. The method of claim 1 further comprising:
receiving user input from the owner of the video item with respect to the plurality of recommended bookmarks and the plurality of recommended bookmark headings; and
providing a plurality of bookmarks for the video item and a bookmark heading for each of the plurality of bookmarks for the video item based on the user input from the owner of the video item.

35. The method of claim 34 wherein the user input from the owner comprises at least one of a group consisting of: user input accepting one or more of the plurality of recommended bookmarks, user input rejecting one or more of the plurality of recommended bookmarks, user input modifying one or more of the plurality of recommended bookmarks, user input accepting one or more of the recommended bookmark headings, user input rejecting one or more of the recommended bookmark headings, and user input modifying one or more of the recommended bookmark headings.

36. The method of claim 34 wherein the user input from the owner is a one-click acceptance.

37. The method of claim 34 further comprising enabling the owner of the video item to utilize the plurality of bookmarks with respect to playback of the video item.

38. The method of claim 34 further comprising enabling a user other than the owner of the video item to utilize the plurality of bookmarks with respect to playback of the video item.

39. The method of claim 1 wherein obtaining the video item comprises receiving the video item from a user device of the owner of the video item via a network.

40. The method of claim 1 wherein the video item is a user-generated video item.

41. A computer readable medium comprising software for instructing a computing system to:
obtain a video item; and
automatically provide a plurality of recommended bookmarks and a plurality of recommended bookmark headings for the video item based on an analysis of at least one of a group consisting of: audio content of the video item and video content of the video item.

42. A central server comprising:
a communication interface communicatively coupling the central server to a user device of a user via a network; and
a control system associated with the communication interface and adapted to:
obtain a video item from the user device of the user via the network; and
automatically provide a plurality of recommended bookmarks and a plurality of recommended bookmark headings for the video item based on an analysis of at least one of a group consisting of: audio content of the video item and video content of the video item.
